(19) United States
(12) Patent Application Publication
(10) Pub. No.: US 2025/0079738 A1
(43) Pub. Date: Mar. 6, 2025

(54) PRINTED CIRCUIT BOARD AND IMAGE FORMING APPARATUS

(71) Applicant: CANON KABUSHIKI KAISHA, Tokyo (JP)

(72) Inventor: HIDEAKI YAMAGUCHI, Shizuoka (JP)

(21) Appl. No.: 18/819,991

(22) Filed: Aug. 29, 2024

(30) Foreign Application Priority Data
Sep. 4, 2023 (JP) 2023-142910

(51) Int. Cl. H01R 12/79; G03G 15/00; H01R 12/77

(52) U.S. Cl. CPC H01R 12/79; G03G 15/80; H01R 12/771; H01R 2201/06

(57) ABSTRACT

A connector mount surface including an outer edge having an edge portion and a connector including a receptacle configured to receive an insertion member. The connector is mounted on the connector mount surface such that (i) the receptacle opens to the edge portion so as to allow the insertion member to be inserted in an insertion direction parallel to the connector mount surface, (ii) the connector is located downstream of the edge portion in the insertion direction, and (iii) the longitudinal direction of the connector extends along the edge portion, wherein the outer edge includes an extending portion extending along the insertion direction, the extending portion being located upstream of the connector in the insertion direction, and wherein, in the longitudinal direction, a downstream end of the extending portion in the insertion direction is located between a first end of the opening and a first end of the connector.

### BACKGROUND

### Field

The present disclosure relates to a printed circuit board and an image forming apparatus including the printed circuit board.

### Description of the Related Art

In some cases, a flexible flat cable (FFC) or a flexible printed circuit board (FPC) is inserted into a connector of a printed circuit board. Japanese Patent Laid-Open No. 2009-099370 discloses a configuration for improving the operation of inserting an FFC into the connector.

### SUMMARY

The present disclosure provides some embodiments of a printed circuit board capable of improving the working efficiency of inserting an insertion member into a connector.

According to some embodiments, the present disclosure provides a printed circuit board to which an insertion member is to be electrically connected, the printed circuit board including a connector mount surface including an outer edge, the outer edge of the connector mount surface having an edge portion extending in a predetermined direction; and a connector including a receptacle configured to receive the insertion member, the connector being mounted on the connector mount surface in such a manner that (i) the receptacle opens to the edge portion so as to allow the insertion member to be inserted in an insertion direction parallel to the connector mount surface, (ii) the connector is located downstream of the edge portion in the insertion direction, and (iii) the longitudinal direction of the connector extends along the edge portion, wherein the outer edge includes an extending portion extending along the insertion direction, the extending portion being located upstream of the connector in the insertion direction, and wherein, in the longitudinal direction, a downstream end of the extending portion in the insertion direction is located between a first end of the opening and a first end of the connector.

Some embodiments of the present disclosure are applicable to an image forming apparatus including the above-described printed circuit board.

Further features of the present disclosure will become apparent from the following description of exemplary embodiments with reference to the attached drawings.

### BRIEF DESCRIPTION OF THE DRAWINGS

FIG. 1 is a diagram illustrating, in outline, the configuration of an image forming apparatus according to some embodiments.

FIGS. 2A and 2B are diagrams illustrating the placement of the exposure unit in the image forming apparatus according to some embodiments.

FIGS. 3A to 3D are diagrams illustrating the configuration of a printed circuit board according to a first embodiment.

FIGS. 4A to 4C are diagrams illustrating the configuration of a printed circuit board according to a second embodiment.

FIGS. 5A to 5C are diagrams illustrating the configuration of a printed circuit board according to a third embodiment.

FIGS. 6A to 6C are diagrams illustrating the configuration of a printed circuit board according to a fourth embodiment.

FIGS. 7A and 7B are diagrams illustrating the configuration of a printed circuit board according to a fifth embodiment.

FIGS. 8A to 8D are diagrams illustrating the configuration of a printed circuit board according to a sixth embodiment.

### DESCRIPTION OF THE EMBODIMENTS

Various exemplary embodiments, features, and aspects of the present disclosure are described below with reference to the drawings.

### First Embodiment

In a first embodiment, an electrophotographic laser beam printer is illustrated as an example of an image forming apparatus that forms images on recording materials.

### Image Forming Apparatus

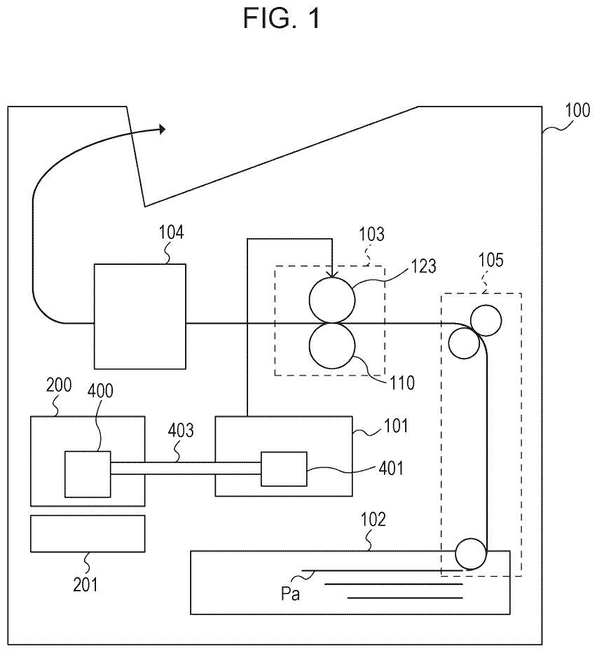

FIG. 1 illustrates, in outline, the configuration of a laser beam printer 100 (hereinafter referred to as a printer 100) according to the first embodiment. Sheets (recording materials) Pa loaded in a sheet cassette 102 are conveyed to an image forming unit 103 by a sheet conveying unit 105. The image forming unit 103 includes a charging section, a developing section, and a cleaning section (not shown) and further includes a photosensitive drum 123 and a transfer unit 110. The surface of the photosensitive drum 123 is charged by the charging section, and an electrostatic latent image is formed on the photosensitive drum 123 by the laser beam output from an exposure unit 101. The electrostatic latent image is developed with toner by the developing section, forming a toner image on the photosensitive drum 123. The toner image formed on the photosensitive drum 123 is transferred onto the conveyed sheet Pa by the transfer unit 110. The toner image transferred onto the sheet Pa is heated and pressed by a fixing unit 104 and is fixed onto the sheet Pa. Thereafter, the sheet Pa is discharged out of the printer 100. The sequence of controls is performed by an engine controller 200.

The positions of the components illustrated in FIG. 1 are not the accurate positions (positional relationship) of the components. For example, the exposure unit 101 is actually located above the image forming unit 103.

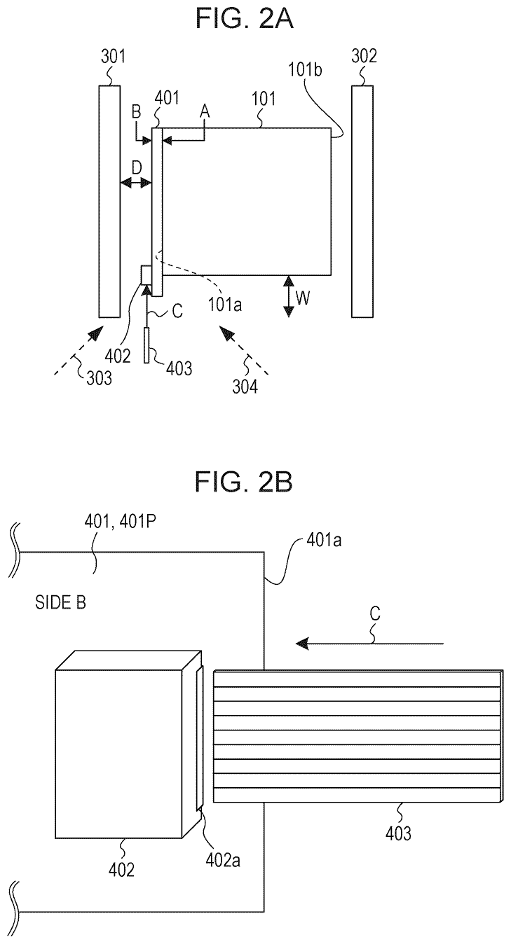

A printed circuit board 400 of the engine controller 200 and a printed circuit board 401 of the exposure unit 101 are connected by a flexible flat cable (FFC) 403. The printed circuit board 401 has an outer edge 401a (see FIG. 2B).

A controller 201 outputs a video signal to the engine controller 200 based on a print command and image information from a host computer (for example, a personal computer). The engine controller 200 outputs the video signal to the exposure unit 101 via the FFC 403. The exposure unit 101 irradiates the photosensitive drum 123 with a laser beam to in response to the video signal received in this manner.

### Placement of Exposure Unit 101

FIG. 2A is a diagram illustrating the placement of the exposure unit 101 in the printer 100 viewed from above. The exposure unit 101 is disposed in the space between a frame 301 (a first frame) of the printer 100 and a frame 302 (a second frame) opposing the frame 301 to form an internal space. In other words, the exposure unit 101 is an example of a unit including a first surface 101a opposing and adjacent to the frame 301 and a second surface 101b opposing and adjacent to the frame 302 and disposed in the internal space.

The printed circuit board 401 of the exposure unit 101 is disposed on a side A (a first surface 101a) of the exposure unit 101 and faces the frame 301. The printed circuit board 401 is disposed on the first surface 101a such that a side B on which a connector 402 (described below) is mounted faces the frame 301.

The printed circuit board 401 includes the connector 402 and a printed wiring board 401P on which the connector 402 is mounted. On the side A of the printed circuit board 401, laser diodes for emitting laser beams are mounted, and on the side B of the printed circuit board 401, the connector 402 to which the FFC 403 is connected is mounted. The printed circuit board 401 includes the side B (a mount surface, a connector mount surface) on which the connector 402 is mounted and the outer edge 401a of the side B (see FIG. 2B). The outer edge 401a of the side B is the outer edge of the side B in the planar direction of the side B (the expanding direction of the side B). In other words, the outer edge 401a is the outer edge of the printed wiring board 401P.

As illustrated in FIG. 2B, the connector 402 is mounted such that the longitudinal direction extends along the outer edge 401a. The connector 402 has a receptacle 402a for the FFC 403. The receptacle 402a is open to the outer edge 401a in the direction parallel to side B. The FFC 403 is inserted into the receptacle 402a of the connector 402 to be electrically connected to the printed circuit board 401 via the connector 402. The FFC 403 is an example of an insertion member inserted into the connector 402.

The connector 402 is a right-angle connector so that the FFC 403 may be inserted into the receptacle 402a in the direction parallel to the side B. More specifically, as illustrated in FIG. 2B, the FFC 403 is connected to the receptacle 402a of the connector 402 along the direction of arrow C, that is, in the direction parallel to the side B of the printed circuit board 401. Arrow C indicates the insertion direction (insertion direction C) of the FFC 403 to the receptacle 402a of the connector 402. The direction of extraction of the FFC 403 from the receptacle 402a is opposite to the insertion direction C.

FIG. 2B is a diagram viewed from the direction indicated by a dashed arrow 303. This is merely for illustrating the relationship between the connector 402 and the FFC 403, in which the frame 301 is omitted. For this reason, this diagram differs from the operator's actual view.

In order for the operator to check the receptacle 402a of the connector 402 from the direction indicated by the dashed arrow 303, the distance D between the frame 301 and the printed circuit board 401 illustrated in FIG. 2A needs to be increased. However, increasing the distance D leads to an increase in the size of the printer 100. In contract, the connector 402 may be disposed opposite to the frame 301, that is, on the side A of the printed circuit board 401. This configuration enables the operator to check the receptacle 402a of the connector 402 from the direction indicated by a dashed arrow 304 but needs to increase the length of the printed circuit board 401 to dispose the connector 402. This configuration needs to increase the distance W illustrated in FIG. 2A, leading to an increase in the size of the printer 100.

### Configuration of Printed Circuit Board 401

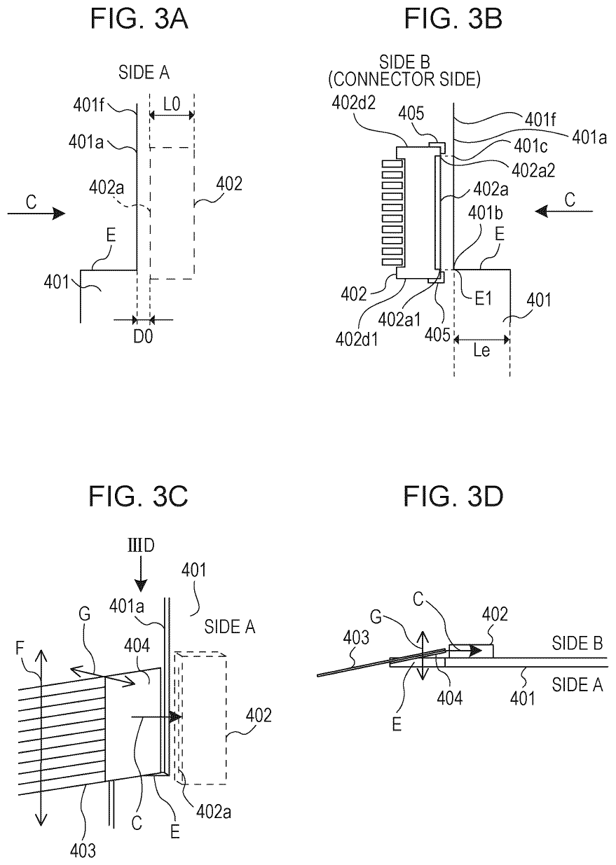

The configuration of the printed circuit board 401 will be described with reference to FIGS. 3A to 3D. FIG. 3A is a view of the printed circuit board 401 viewed from the back of the mount surface for the connector 402 (hereinafter referred to as the side A). In the case where the connector 402 is mounted on the side B of the printed circuit board 401 and viewed from the dashed arrow 304 in FIG. 2A, the connector 402 is located on the back of the printed circuit board 401.

The outer edge 401a has an edge portion 401f extending in a predetermined direction. In the insertion direction C in FIGS. 3A to 3D, the connector 402 is mounted on the side B so as to be located downstream from the edge portion 401f such that its longitudinal direction extends along the edge portion 401f. The edge portion 401f and the longitudinal direction of the connector 402 may be parallel. The edge portion 401f extends in a direction crossing (or perpendicular to) the insertion direction C of the FFC 403.

The receptacle 402a of the connector 402 is open to the outer edge 401a (more specifically, to the edge portion 401f). Accordingly, the FFC 403 is inserted into the connector 402 in the insertion direction C from the edge portion 401f to the connector 402.

In the direction perpendicular to the side B, the distance between the connector 402 and the edge portion 401f in the insertion direction C is smaller than the length of the connector 402 in the lateral direction. Here, the length of the connector 402 in the lateral direction is defined as length L0, and the distance between the connector 402 and the edge portion 401f is defined as distance (shortest distance) D0. The connector 402 of the first embodiment is disposed in the vicinity of the edge portion 401f of the outer edge 401a. The distance D0 is smaller than the length of the connector 401 in the longitudinal direction and smaller the length L0 (L0>D0).

The connector 402 is located on the back of the printed circuit board 401. For this reason, in order to visually inspect the connector 402, the operator needs to look inside from the direction indicated by the dashed arrow 303 in FIG. 2A, which makes it difficult to visually inspect the connector 402.

FIG. 3B is a view of the printed circuit board 401 viewed from the mount surface for the connector 402 (hereinafter referred to as the side B or the connector side). FIGS. 3A and 3B are plan views of the printed circuit board 401 in the direction perpendicular to the side B.

The connector 402 is mounted on the side B of the printed circuit board 401. In the first embodiment, the connector 402 is a surface-mounted component and includes a hold-down portion 405 for enhancing the retention strength of the connector 402 to the printed wiring board 402P. The hold-down portion 405 is connected and fixed to the printed circuit board 401 by soldering.

In the longitudinal direction of the connector 402, the connector 402 has a first end 402d1 and a second end 402d2 opposite to the first end 402d1. In the longitudinal direction of the connector 402, the receptacle 402a has a first end 402a1 and a second end 402a2 opposite to the first end 402a1. In the longitudinal direction of the connector 402, the first end 402d1 of the connector 402 and the first end 402a1 of the receptacle 402a are located on one side of the center of the receptacle 402. In the longitudinal direction of the connector 402, the second end 402d2 of the connector 402 and the second end 402a2 of the receptacle 402a are located on the other side of the center of the receptacle 402.

Here, as illustrated in FIG. 3B, a position 401b and a position 401c of the outer edge 401a are defined as follows. The position 401b is between the first end 402a1 of the receptacle 402a and the first end 402d1 of the connector 402 in the longitudinal direction of the connector 402. The position 401b includes the same position as that of the first end 402a1 of the receptacle 402a and the same position as that of the first end 402d1 of the connector 402. The position 401c is between the second end 402a2 of the receptacle 402a and the second end 402d2 of the connector 402 in the longitudinal direction of the connector 402. The position 401c includes the same position as that of the second end 402a2 of the receptacle 402a and the same position as that of the second end 402d2 of the connector 402.

The printed circuit board 401 includes an extension (extending portion) E extending along the insertion/extraction direction (the insertion direction C/extraction direction) of the FFC 403 at the position 401b corresponding to an end of the receptacle 402a of the connector 402. In other words, the outer edge 401a includes the extension E. The extension E is part of the printed wiring board 401P. It can also be said that the extension E extends in a direction intersecting the longitudinal direction of the connector 402. The extension E extends from the edge portion 401f in the direction opposite to the insertion direction C.

In other words, the extension E is located upstream of the connector 402 in the insertion direction C of the FFC 403. In the longitudinal direction of the connector 402, a downstream end E1 of the extension E in the insertion direction of the FFC 403 is located at the position 401b. In other words, the downstream end E1 of the extension E is located between the first end 402a1 of the receptacle 402a and the first end 402d1 of the connector 402 in the longitudinal direction of the connector 402. In this embodiment, the entire extension E is located between the first end 402a1 of the receptacle 402a and the first end 402d1 of the connector 402 in the longitudinal direction of the connector 402.

The downstream end E1 of the extension E is disposed in the vicinity of the connector 402. In the direction perpendicular to the side B, the distance between the connector 402 and the downstream end E1 in the insertion direction C is smaller than the length of the connector 402 in the lateral direction. In this embodiment, the shortest distance between the connector 402 and the downstream end E1 is smaller than the length of the connector 402 in the lateral direction.

In this embodiment, the area of the wiring section (wiring pattern) of the printed wiring board 401P overlaps with at least part of the extension E in the insertion direction C.

In the first embodiment, the extension E is provided at the position 401b corresponding to the lower end of the receptacle 402a of the connector 402 in FIG. 3B. Alternatively, an extension may be provided at the position 401c corresponding to the upper end. The length Le of the extension E is preferably larger than the length L0 of the connector 402 in the lateral direction (Le>L0) in consideration of the work efficiency of the operator (described below). For example, the length Le of the extension E is preferably about 5 mm (millimeters) or more. The length Le of the extension E may be larger than the length of the connector 402 in the longitudinal direction.

In order to smooth the extension E, the extension E may be unperforated or in V-cut so that no burr is produced on the printed circuit board 401.

FIG. 3C is a view of the printed circuit board 401 viewed from side A illustrating a state in which the FFC 403 is inserted into the connector 402. In this state, it is difficult for the operator to visually inspect the connector 402. How the user smoothly inserts the FFC 403 into the receptacle 402a of the connector 402 using the extension E of the printed circuit board 401 even in such a state will be described hereinbelow.

When inserting the FFC 403 into the receptacle 402a of the connector 402, the operator brings an end of the FFC 403 into contact with the extension E of the printed circuit board 401 while holding the FFC 403 and slides the FFC 403 in the direction of arrow C (insertion direction C) as it is. The position of connector 402 in the direction of arrow F (the vertical direction) relative to the receptacle 402a is fixed. This therefore allows the operator to insert the FFC 403 into the connector 402 only by aligning the position of the receptacle 402a of the connector 402 with the FFC 403 in the direction of arrow G (depth direction).

In other words, the FFC 403 may be inserted into the connector 402, with the FFC 403 in contact with the extension E. Specifically, the FFC 403 may be inserted into the connector 402, with the portion of the FFC 403 that houses wiring lines in contact with the extension E.

Since the operator has particular difficulty in locating the position in the direction of arrow G, determining the position in the direction of arrow G makes it remarkably easy to insert the FFC 403 into the connector 402.

By bringing a reinforcing board 404 for the FFC 403 into contact with the extension E of the printed circuit board 401, the FFC 403 becomes less prone to bending, making the operation easier. Since the downstream end E1 of the extension E is disposed in the vicinity of the connector 402, the extension E can guide the FFC 403 to the vicinity of the connector 402.

FIG. 3D is a diagram of FIG. 3C viewed from arrow IIID. The connector 402 is mounted on the side B of the printed circuit board 401. The operator performs the operation from side A of the printed circuit board 401. The operator brings the FFC 403 or the reinforcing board 404 into contact with the extension E and slides the FFC 403 in the direction of arrow C (insertion direction C) into the connector 402. Only by aligning the FFC 403 in the direction of arrow G, the operator can easily insert the FFC 403 into the connector 402.

The printer 100 includes a large number of printed circuit boards in addition to the printed circuit board 400 and the printed circuit board 401. As a means for connecting the large number of printed circuit boards, inexpensive space-saving FFCs are often used. Therefore, there are many situations where embodiments of the present disclosure are applicable to the printer 100. In other words, units including the printed circuit board to which embodiments of the present disclosure are applicable are not limited to the exposure unit 101.

In some cases, for example, a process for irradiating the surface of the photosensitive drum 123 with light (hereinafter referred to as pre-exposure) using light emitting diodes (LEDs) or similar sources is performed before a charging process for the photosensitive drum 123 to make the surface potential of the photosensitive drum 123 uniform. Since the pre-exposure processing applies the light toward the interior of the printer 100, the mounting of the printed circuit board to the printer 100 is typically performed such that the component mount surface of the printed circuit board faces the interior of the printer 100. In this case, the connector of the FFC is present on the back of the printed circuit board viewed from the operator, so that the connector of the FFC cannot easily be viewed. Even in such a situation, application of the first embodiment allows the operator to easily insert the FFC into the connector.

According to the first embodiment, the working efficiency of inserting the insertion member into the connector is improved.

### Second Embodiment

### Configuration of Printed Circuit Board 401

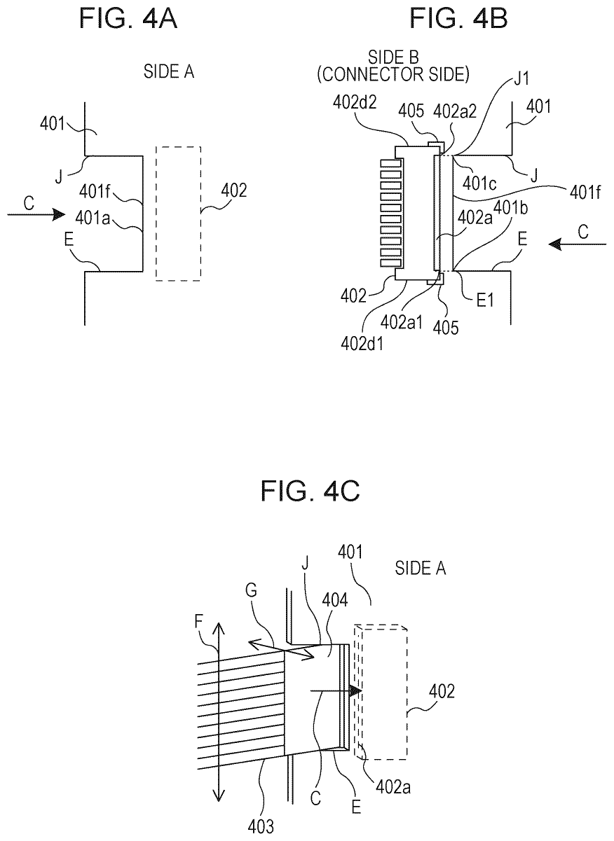

In a second embodiment, difference from the first embodiment will be mainly described with reference to FIGS. 4A to 4C. In the second embodiment, when the extension E is referred to as a first extension, the outer edge 401a of the printed circuit board 401 includes an extension (a second extension) J extended along the FFC 403 insertion/extraction direction at the position 401c corresponding to the second end in the longitudinal direction.

The extension J is part of the printed wiring board 401P. In other words, the extension J extends in the direction intersecting the longitudinal direction of the connector 402.

In other words, the extension J is located upstream of the connector 402 in the FFC 403 insertion direction. In the longitudinal direction of the connector 402, the downstream end J1 of the extension J in the FFC 403 insertion direction is located at the position 401c. In other words, in the longitudinal direction of the connector 402, the downstream end J1 of the extension J is located between the second end 402a2 of the receptacle 402a and the second end 402d2 of the connector 402. In this embodiment, the entire extension J is located between the second end entire 402a2 of the receptacle 402a and the second end 402d2 of the connector 402 in the longitudinal direction of the connector 402.

In this embodiment, the area of the wiring section (wiring pattern) of the printed wiring board 401P overlaps with at least part of the extension E and at least part of the extension J in the insertion direction C.

FIG. 4A is a view of the printed circuit board 401 viewed from side A. FIG. 4B is a view of the printed circuit board 401 viewed from side B. The connector 402 is mounted on the side B of the printed circuit board 401. The connector 402 includes a hold-down portion 405. The printed circuit board 401 includes an extension E at a position 401b corresponding to the lower end of the receptacle 402a of the connector 402 and an extension J at the position 401c corresponding to the upper end of the receptacle 402a. The lengths of the extension E and the extension J are preferably about 5 mm or more in consideration of the working efficiency of the operator (described below). The extension E and the extension J may be longer than the length of the connector 402 in the lateral direction and longer than the longitudinal direction of the connector 402.

In order to smooth the extension E and the extension J, the extension E and the extension J may be unperforated or in V-cut so that no burr is produced on the printed circuit board 401.

FIG. 4C is a view of the printed circuit board 401 viewed from side A illustrating a state in which the FFC 403 is inserted into the connector 402.

When inserting the FFC 403 into the receptacle 402a of the connector 402, the operator holds the FFC 403 such that the FFC 403 is in contact with one of the extension E and the extension J.

Since the distance between the extension E and the extension J is substantially equal to the width of the FFC 403, the position of the FFC 403 in the direction of arrow F is determined relative to the receptacle 402a of the connector 402.

This therefore allows the operator to insert the FFC 403 into the connector 402 only by aligning the position of the receptacle 402a of the connector 402 with the FFC 403 in the direction of arrow G (depth direction) when sliding the FFC 403 in the direction of arrow C (insertion direction C).

In other words, the FFC 403 may be inserted into the connector 402, with the FFC 403 in contact with the extension E and the extension J. Specifically, the FFC 403 may be inserted into the connector 402, with part of the FFC 403 that houses wiring lines in contact with the extension E or the extension J. The FFC 403 may be inserted into the connector 402, with the FFC in contact with both of the extension E and the extension J.

Since in the second embodiment the position of the FFC 403 in the vertical direction is determined by the extension J, the working efficiency of the operator in inserting the FFC 403 into the connector 402 is further improved.

According to the second embodiment, the working efficiency of inserting the insertion member into the connector is improved.

### Third Embodiment

### Configuration of Printed Circuit Board 401

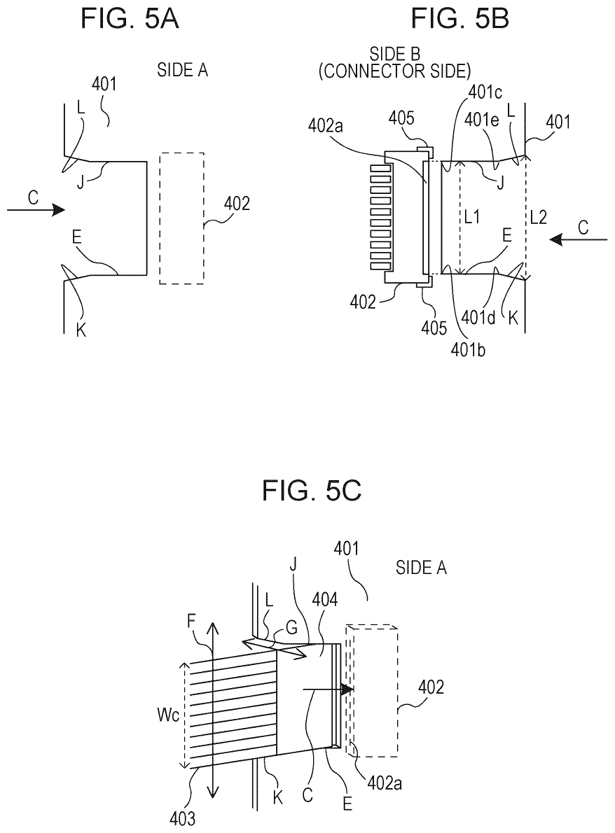

In a third embodiment, a method for further improving the working efficiency of the operator will be described with reference to FIGS. 5A to 5C.

In the third embodiment, the distance between the extension E and the extension J increases with an increasing distance from the receptacle 402a.

FIG. 5A is a view of the printed circuit board 401 viewed from side A. FIG. 5B is a view of the printed circuit board 401 viewed from side B. The connector 402 is mounted on the side B of the printed circuit board 401. The connector 402 includes a hold-down portion 405. The printed circuit board 401 includes an extension E (a first extension) at a position 401b corresponding to the lower end of the receptacle 402a of the connector 402 and an extension J (a second extension) at a position 401c corresponding to the upper end of the receptacle 402a.

As illustrated in FIG. 5B, the printed circuit board 401 further includes an extension K that changes in extending direction at the end of the extension E remote from the connector 402 and an extension L that changes in extending direction at the end of the extension J remote from the connector 402. In other words, in the insertion direction of the connector 402, the extension K is connected to the upstream end of the extension E, and the extension L is connected to the upstream end of the extension J.

In this manner, in the third embodiment, the extension E connects to the extension K (a third extension) at a position remote from the connector 402, and the extension J connects to the extension L (a fourth extension) at a position remote from the connector 402. The extending direction of the extension E differs from the extending direction of the extension K. The extending direction of the extension J differs from the extending direction of the extension L.

The distance L1 between the extension E and the extension J in the vicinity of the connector 402 is substantially equal to the width Wc of the FFC 403 (L1≈Wc), and the distance L2 between the right end of the extension K and the right end of the extension L (the distance between the board edges) in FIG. 5B is larger than the width Wc of the FFC 403 (L2>Wc). Thus, the distance L2 between the extension K and the extension L in the longitudinal direction is larger than the distance L1 between the extension E and the extension J in the longitudinal direction. The distance L1 between the extension E and the extension J in the longitudinal direction is equal to the length of the connector 402 in the longitudinal direction, and the distance L2 between the extension K and the extension L in the longitudinal direction is larger than the length of the connector 402 in the longitudinal direction.

FIG. 5C is a view of the printed circuit board 401 viewed from side A illustrating a state in which the FFC 403 is inserted into the connector 402. The operator holds the FFC 403 and moves the FFC 403 from the left between the extension K and the extension L, then slides the FFC 403 in the direction of arrow C (insertion direction C) to guide the FFC 403 between the extension E and the extension J. At the point in time when the FFC 403 reaches a position between the extension E and the extension J, the position of the FFC 403 in the direction of arrow F is determined relative to the receptacle 402a of the connector 402. The operator continues to slide the FFC 403 in the direction of arrow C (insertion direction C) to align the receptacle 402a of the connector 402 and the FFC 403 in the direction of arrow G (depth direction) and inserts the FFC 403 into the connector 402.

Since the distance L1 between the extension E and the extension J is substantially equal to the width Wc of the FFC 403, it may be difficult for the operator to guide the FFC 403 between the extension E and the extension J.

For this reason, shaping the printed circuit board 401 as in FIGS. 5A to 5C makes it easy for the operator to guide the FFC 403 between the extension E and the extension J, further enhancing the working efficiency of the operator to insert the FFC 403 into the connector 402.

As illustrated in FIG. 5B, in the third embodiment, the extension E is extended in the same direction to a position 401d, where the extending direction is changed to form the extension L. The extension J is extended in the same direction to a position 401e, where the extending direction is changed to form the extension K. This is illustrative only. For example, the extending direction may be gradually changed from the positions 401b and 401c. Although in the third embodiment the extension E is bent at an angle at the positions 401d and 401e, the extending direction may be changed so as to form a curve.

According to the third embodiment, the working efficiency of inserting the insertion member into the connector is improved.

### Fourth Embodiment

### Configuration of Printed Circuit Board 401

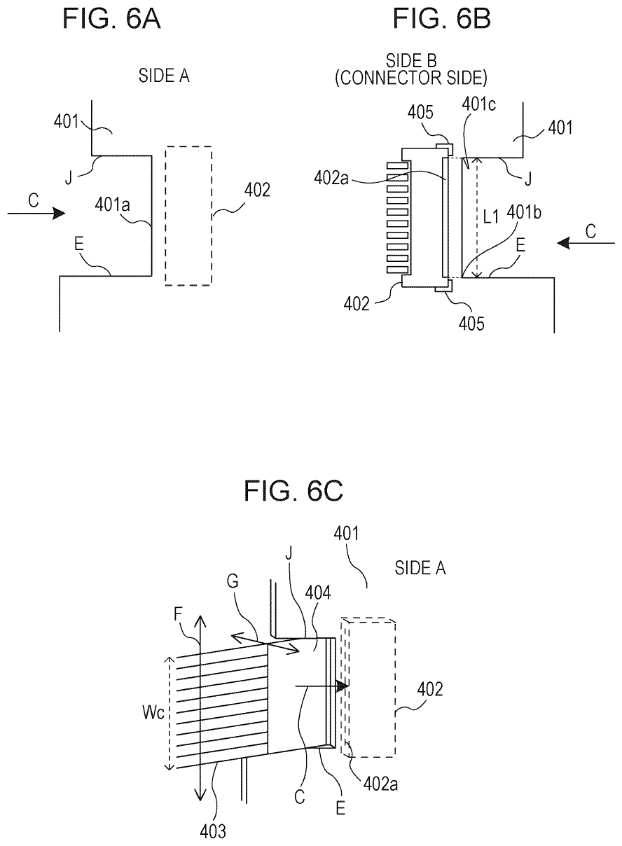

In a fourth embodiment, the configuration of the printed circuit board 401 as in FIGS. 6A to 6C makes it easy for the operator to guide the FFC 403 between the extension E and the extension J as with the configuration of the third embodiment. In the fourth embodiment, the lengths of the extension E and the extension J in the insertion/extraction direction differ.

FIG. 6A is a view of the printed circuit board 401 viewed from side A. FIG. 6B is a view of the printed circuit board 401 viewed from side B. The connector 402 is mounted on the side B of the printed circuit board 401. The connector 402 includes a hold-down portion 405. The printed circuit board 401 includes an extension E at a position 401b corresponding to the lower end of the receptacle 402a of the connector 402 and an extension J at a position 401c corresponding to the upper end of the receptacle 402a. As illustrated in FIG. 6B, the lengths of the extension E and the extension J in the direction of arrow C (insertion direction C) differ, and in the fourth embodiment, the extension E is longer than the extension J. The extension J may be longer than the extension E. The distance L1 between the extension E and the extension J is substantially equal to the width Wc of the FFC 403.

FIG. 6C is a view of the printed circuit board 401 viewed from side A illustrating a state in which the FFC 403 is inserted into the connector 402. When inserting the FFC 403 into the receptacle 402a of the connector 402, the operator brings an end of the FFC 403 into contact with the front edge of the extension E of the printed circuit board 401 while holding the FFC 403. The operator slides the FFC 403 along the extension E in the direction of arrow C (insertion direction C), so that the FFC 403 is smoothly guided between the extension E and the extension J. The configuration in FIGS. 6A to 6C allows the operator to guide the FFC 403 between the extension E and the extension J without catching, further improving the working efficiency of the operator to insert the FFC 403 into the connector 402.

According to the fourth embodiment, the working efficiency of inserting the insertion member into the connector is improved.

### Fifth Embodiment

### Configuration of Printed Circuit Board 401

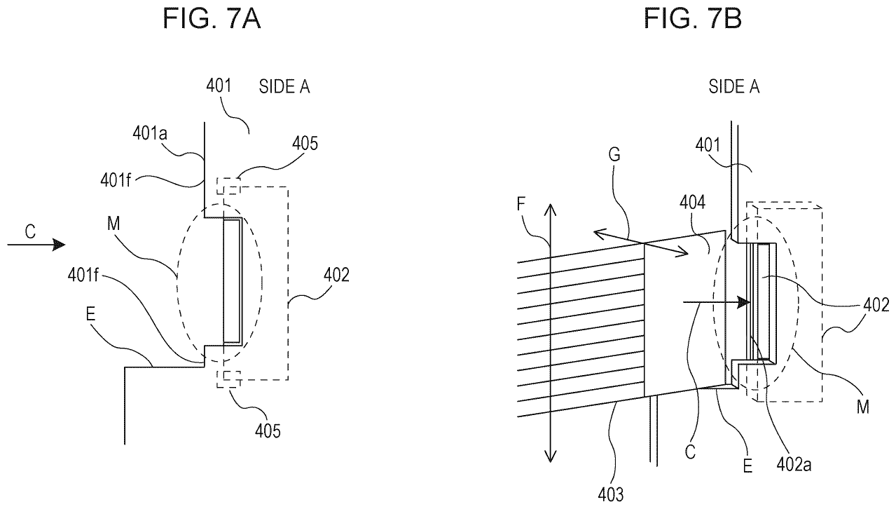

In a fifth embodiment, a configuration for further improving the working efficiency of the operator to insert the FFC 403 into the connector 402 will be described with reference to FIGS. 7A and 7B. In the fifth embodiment, the outer edge 401a has a cutout portion (a recessed portion) M recessed into the printed circuit board 401 so that at least part of the receptacle 402a is exposed. At least part of the connector 402 is exposed from the cutout portion M to the back of the side B. The cutout portion M is a recessed portion recesses from the edge portion 401f toward the connector 402 (in the insertion direction C).

FIGS. 7A and 7B are views of the printed circuit board 401 viewed from side A. In the fifth embodiment, in addition to the configuration of FIGS. 3A to 3D according to the first embodiment, the recessed cutout portion M is provided at an end of the printed circuit board 401, a position directly below the connector 402 and corresponding to the direction of the receptacle 402a, as illustrated in FIGS. 7A and 7B. Providing the cutout portion M allows the operator to check part of the connector 402 and the receptacle 402a from side A through the cutout portion M.

The connector 402 may include the hold-down portion 405, in which case not the entire position directly below the connector 402 cannot be notched out and eliminated. Accordingly, in the fifth embodiment, the cutout portion M is recessed in a way that avoids the hold-down portion 405.

How the operator inserts the FFC 403 into the connector 402 will be described with reference to FIG. 7B. The operator brings an end of the FFC 403 into contact with the front edge of the extension E of the printed circuit board 401 while holding the FFC 403. The operator slides the FFC 403 along the extension E in the direction of arrow C (insertion direction C), and at the point in time when the FFC 403 reaches the receptacle 402a of the connector 402, inserts the FFC 403 into the connector 402 while checking the position of the receptacle 402a. The method described above allows the operator to visually determine the position of the FFC 403 in the direction of arrow G while determining the position relative to the receptacle 402a of the connector 402 in the direction of arrow F (in the vertical direction), further improving the working efficiency of inserting the FFC 403 into the connector 402.

According to the fifth embodiment, the working efficiency of inserting the insertion member into the connector is improved.

### Sixth Embodiment

### Configuration of Printed Circuit Board 401

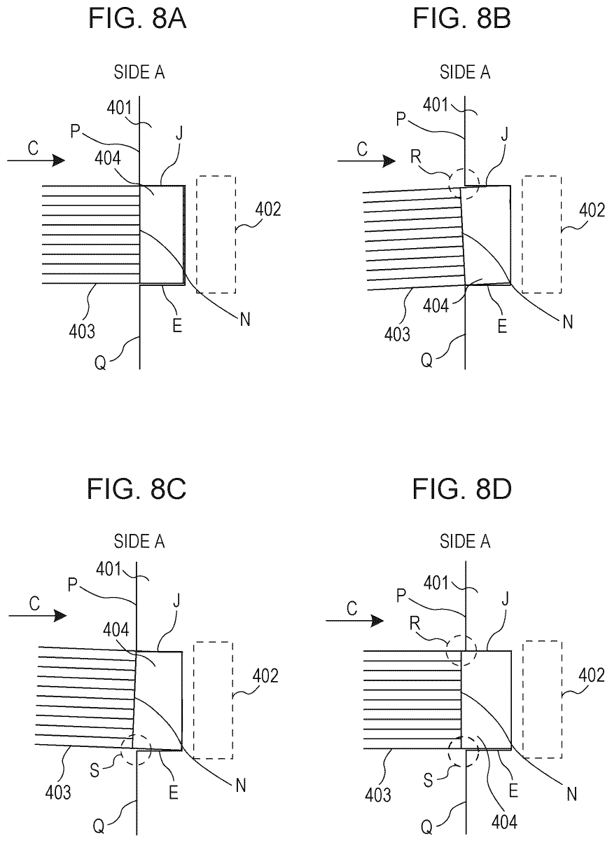

In a sixth embodiment, a configuration in which the operator may confirm that, after inserting the FFC 403 into the connector 402, the FFC 403 is properly inserted will be described with reference to FIGS. 8A to 8D. Here, “properly inserted” means that the FFC 403 is not inserted at an angle into the connector 402 and that the FFC 403 is fully inserted into the depth of the receptacle 402a of the connector 402. The sixth embodiment is applicable to the first to fourth embodiments. In the sixth embodiment, the FFC 403 includes a reinforcing board 404 extending, in the insertion/extraction direction, in the direction opposite to the part that is inserted into the receptacle 402a. The reinforcing board 404 includes a reinforcing board edge N which is a side edge that is aligned with the outer edge 401a in a straight line when the FFC 403 in properly inserted into the receptacle 402a.

FIG. 8A is a view of the printed circuit board 401 viewed from side A illustrating a state in which the connector 402 is mounted on the side B, and the FFC 403 is properly inserted into the connector 402.

The printed circuit board 401 includes an extension E and an extension J extending in the insertion/extraction direction of the FFC 403 at the positions aligned with the opposite ends of the receptacle 402a of the connector 402. In the sixth embodiment, when the FFC 403 is properly inserted into the connector 402, the reinforcing board edge N of the reinforcing board 404 of the FFC 403 aligns in the lateral direction with a board edge P and a board edge Q of the printed circuit board 401, forming a straight line. In this manner, the length of the reinforcing board 404 of the FFC 403 and the lengths of the extension E and the extension J of the printed circuit board 401 are adjusted.

The outer edge 401a includes the board edge Q (a first outer edge) and the board edge P (a second outer edge). The board edge Q is located upstream of the extension E in the insertion direction C and extends in the direction parallel to the longitudinal direction of the connector 402 and away from the connector 402. The board edge P is located upstream of the extension J in the insertion direction C and extends in the direction parallel to the longitudinal direction of the connector 402 and away from the connector 402.

FIG. 8B is a diagram illustrating a state in which the FFC 403 is inserted into the connector 402, with the leading end tilted upwards. In this case, the reinforcing board edge N of the FFC 403 is out of alignment with the board edge P and the board edge Q in the lateral direction, not forming a straight line. A large misalignment occurs between the reinforcing board edge N and the board edge P, particularly at a board corner R of the printed circuit board 401.

Similarly, FIG. 8C illustrates a state in which the FFC 403 is inserted into the connector 402, with the leading end of the FFC 403 tilted downward. In this case, the reinforcing board edge N of the FFC 403 is out of alignment with the board edge P and the board edge Q in the lateral direction, not forming a straight line. A large misalignment occurs between the reinforcing board edge N and the board edge Q, in particular, at a board corner S of the printed circuit board 401.

FIG. 8D is a diagram illustrating a state in which the FFC 403 is partially inserted into the connector 402, not fully inserted into the depth of the connector 402. In this case, the reinforcing board edge N of the FFC 403 are out of alignment with the board edge P and the board edge Q in the lateral direction, not forming a straight line. At both of the board corner R and the board corner S of the printed circuit board 401, misalignment occurs between the reinforcing board edge N and the board edges P and Q, causing a level-difference.

As has been described, the configuration of the printed circuit board 401 of the sixth embodiment allows the operator to determine whether the FFC 403 is properly inserted into the connector 402 by checking the misalignment between the reinforcing board edge N and the board edges P and Q. Although in the sixth embodiment the printed circuit board 401 is provided with two extensions, the extension E and the extension J, the printed circuit board 401 may be provided with just one extension.

According to the sixth embodiment, the working efficiency of inserting the insertion member into the connector is improved.

### Modification

The above embodiments illustrate the FFC 403 by an example of the insertion member to be inserted into the connector 402. Alternatively, the insertion member to be inserted into the connector 402 may be a flexible printed wiring board (FPC).

In the embodiments and the modification, the insertion member may have the following cross-sectional shape perpendicular to the insertion direction C into the connector 402. The cross-section of the insertion member may be larger in the length (width) perpendicular to the insertion direction C than the length (thickness) in the thickness direction perpendicular to the width direction. At the portion where the insertion member is inserted into the connector 402, the thickness direction of the cross-section of the insertion member may intersect the side B and may be perpendicular to the side B.

An embodiment of the present disclosure may provide a printed circuit board capable of improving the working efficiency of inserting an insertion member into the connector.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2023-142910, filed Sep. 4, 2023, which is hereby incorporated by reference herein in its entirety.

What is claimed is:

1. A printed circuit board to which an insertion member is to be electrically connected, the printed circuit board comprising:
a connector mount surface including an outer edge, the outer edge of the connector mount surface having an edge portion extending in a predetermined direction; and
a connector including a receptacle configured to receive the insertion member, the connector being mounted on the connector mount surface in such a manner that (i) the receptacle opens to the edge portion so as to allow the insertion member to be inserted in an insertion direction parallel to the connector mount surface, (ii) the connector is located downstream of the edge portion in the insertion direction, and (iii) the longitudinal direction of the connector extends along the edge portion,
wherein the outer edge includes an extending portion extending along the insertion direction, the extending portion being located upstream of the connector in the insertion direction, and
wherein, in the longitudinal direction, a downstream end of the extending portion in the insertion direction is located between a first end of the opening and a first end of the connector.

2. The printed circuit board according to claim 1, wherein, in a direction perpendicular to the connector mount surface, a distance between the connector and the edge portion in the insertion direction is smaller than a length of the connector in a lateral direction.

3. The printed circuit board according to claim 1, wherein, in a direction perpendicular to the connector mount surface, a distance between the connector and the downstream end in the insertion direction is smaller than a length of the connector in a lateral direction.

4. The printed circuit board according to claim 1, wherein the extending portion is longer than a length of the connector in a lateral direction.

5. The printed circuit board according to claim 1, wherein, when the extending portion is referred to as a first extending portion,
the outer edge includes a second extending portion extending in the insertion direction, the second extending portion being located upstream of the connector in the insertion direction, a downstream end of the second extending portion in the insertion direction being located between a second end of the opening and a second end of the connector in the longitudinal direction.

6. The printed circuit board according to claim 5, wherein the first extending portion and the second extending portion have different lengths in the insertion direction.

7. The printed circuit board according to claim 5,
wherein the first extending portion connects to a third extending portion at a position away from the connector, the first extending portion extending in a direction different from an extending direction of the third extending portion,
wherein the second extending portion connects to a fourth extending portion at a position away from the connector, the second extending portion extending in a direction different from an extending direction of the fourth extending portion, and
wherein a distance between the third extending portion and the fourth extending portion in the longitudinal direction is larger than a distance between the first extending portion and the second extending portion in the longitudinal direction.

8. The printed circuit board according to claim 7,
wherein the distance between the first extending portion and the second extending portion in the longitudinal direction is equal to a length of the connector in the longitudinal direction, and
wherein the distance between the third extending portion and the fourth extending portion in the longitudinal direction is larger than the length of the connector in the longitudinal direction.

9. The printed circuit board according to claim 1, wherein the outer edge has a recessed portion recessed into the connector mount surface so as to expose at least part of the connector to a back of the connector mount surface.

10. The printed circuit board according to claim 1, wherein the insertion member comprises a flexible flat cable or a flexible printed circuit board.

11. An image forming apparatus comprising:
a first frame;
a second frame opposing the first frame to form an internal space;
a unit in the internal space; and
a printed circuit board to which an insertion member is to be electrically connected, the printed circuit board including:
a connector mount surface including an outer edge, the outer edge of the connector mount surface having an edge portion extending in a predetermined direction;
a connector including a receptacle configured to receive the insertion member, the connector being mounted on the connector mount surface in such a manner that (i) the receptacle opens to the edge portion so as to allow the insertion member to be inserted in an insertion direction parallel to the connector mount surface, (ii) the connector is located downstream of the edge portion in the insertion direction, and (iii) the longitudinal direction of the connector extends along the edge portion; and
the insertion member,
wherein the outer edge includes an extending portion extending along the insertion direction, the extending portion being located upstream of the connector in the insertion direction,
wherein, in the longitudinal direction, a downstream end of the extending portion in the insertion direction is located between a first end of the opening and a first end of the connector, and
wherein the connector mount surface faces the first frame.

12. The image forming apparatus according to claim 11, wherein, in a direction perpendicular to the connector mount surface, a distance between the connector and the edge portion in the insertion direction is smaller than a length of the connector in a lateral direction.

13. The image forming apparatus according to claim 11, wherein, in a direction perpendicular to the connector mount surface, a distance between the connector and the downstream end in the insertion direction is smaller than a length of the connector in a lateral direction.

14. The image forming apparatus according to claim 11, wherein the extending portion is longer than a length of the connector in a lateral direction.

15. The image forming apparatus according to claim 11, wherein, when the extending portion is referred to as a first extending portion,
the outer edge includes a second extending portion extending in the insertion direction, the second extending portion being located upstream of the connector in the insertion direction, a downstream end of the second extending portion in the insertion direction being located between a second end of the opening and a second end of the connector in the longitudinal direction.

16. The image forming apparatus according to claim 15, wherein the first extending portion and the second extending portion have different lengths in the insertion direction.

17. The image forming apparatus according to claim 15,
wherein the first extending portion connects to a third extending portion at a position away from the connector, the first extending portion extending in a direction different from an extending direction of the third extending portion,
wherein the second extending portion connects to a fourth extending portion at a position away from the connector, the second extending portion extending in a direction different from an extending direction of the fourth extending portion, and
wherein a distance between the third extending portion and the fourth extending portion in the longitudinal direction is larger than a distance between the first extending portion and the second extending portion in the longitudinal direction.

18. The image forming apparatus according to claim 17,
wherein the distance between the first extending portion and the second extending portion in the longitudinal direction is equal to a length of the connector in the longitudinal direction, and
wherein the distance between the third extending portion and the fourth extending portion in the longitudinal direction is larger than the length of the connector in the longitudinal direction.

19. The image forming apparatus according to claim 11, wherein the outer edge has a recessed portion recessed into the connector mount surface so as to expose at least part of the connector to a back of the connector mount surface.

20. The image forming apparatus according to claim 11, wherein the insertion member comprises a flexible flat cable or a flexible printed circuit board.
